(19) United States
(12) Patent Application Publication
(10) Pub. No.: US 2026/0067044 A1
(43) Pub. Date: Mar. 5, 2026

(54) DEMODULATION REFERENCE SIGNAL (DMRS) PATTERNS FOR CROSS START AND LENGTH INDICATOR VALUE (SLIV)/SLOT COMBINING

(71) Applicant: QUALCOMM Incorporated, San Diego, CA (US)

(72) Inventors: Chih-Hao LIU, San Diego, CA (US); Jing SUN, San Diego, CA (US); Tingfang JI, San Diego, CA (US); Jing JIANG, San Diego, CA (US)

(21) Appl. No.: 18/825,932

(22) Filed: Sep. 5, 2024

(51) Int. Cl. H04L 5/00; H04W 72/0446

(52) U.S. Cl. CPC H04L 5/0048; H04W 72/0446

(57) ABSTRACT

Certain aspects of the present disclosure provide techniques for demodulation reference signal (DMRS) patterns for cross start and length indicator value (SLIV)/slot combining. An example method, performed at a receiver, generally includes processing signaling indicating at least one time-varying demodulation reference signal (DMRS) pattern for DMRS combining, receiving, according to the at least one time-varying DMRS pattern, at least a first DMRS in a first time interval and at least a second DMRS in at least a second time interval, performing channel estimation based on DMRS combining of the first DMRS and the second DMRS, and decoding at least one data channel transmission based on the channel estimation.

### FIELD OF THE DISCLOSURE

Aspects of the present disclosure relate to wireless communications, and more particularly, to techniques for demodulation reference signal (DMRS) processing.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication at a receiver. The method includes processing signaling indicating at least one time-varying demodulation reference signal (DMRS) pattern for DMRS combining; receiving, according to the at least one time-varying DMRS pattern, at least a first DMRS in a first time interval and at least a second DMRS in at least a second time interval; performing channel estimation based on DMRS combining of the first DMRS and the second DMRS; and decoding at least one data channel transmission based on the channel estimation.

Another aspect provides a method for wireless communication at a transmitter. The method includes processing signaling indicating at least one time-varying demodulation reference signal (DMRS) pattern for DMRS combining; transmitting, according to the at least one time-varying DMRS pattern, at least a first DMRS in a first time interval and at least a second DMRS in at least a second time interval; and transmitting at least one data channel transmission in at least one of the first time interval or the at least the second time interval.

Other aspects provide: an apparatus operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example of causal cross-slot combining.

FIG. 6 depicts an example of non-causal cross-slot combining.

FIG. 7 depicts an example of non-causal cross-slot combining.

FIG. 8 depicts a call flow diagram, in accordance with aspects of the present disclosure.

FIG. 9 depicts an example of a cross start and length indicator value (SLIV) demodulation reference signal (DMRS) pattern for causal DMRS combining, in accordance with aspects of the present disclosure.

FIG. 10 depicts an example of a cross-SLIV DMRS pattern for causal DMRS combining, in accordance with aspects of the present disclosure.

FIG. 11 depicts an example of a cross-SLIV DMRS pattern for non-causal DMRS combining, in accordance with aspects of the present disclosure.

FIG. 12 depicts an example of signaling for a time varying DMRS pattern in a per-SLIV grant.

FIG. 13 depicts a method for wireless communications.

FIG. 14 depicts a method for wireless communications.

FIG. 15 depicts aspects of an example communications device.

### DETAILED DESCRIPTION

Aspects of the present disclosure provide apparatuses, methods, processing systems, and computer-readable mediums for demodulation reference signal (DMRS) processing, for example, based on patterns for cross start and length indicator value (SLIV)/slot combining.

A user equipment (UE) may measure a demodulation reference signal (DMRS) in a downlink message to estimate a channel. The UE may obtain a more accurate channel estimate if the DMRS is jointly estimated with another DMRS of another transmission time interval (TTI). A TTI may include, for example, a slot (e.g., which may be indicated by an SLIV). In some cases, the UE may use causal cross-slot DMRS combining for joint channel estimation, in which the UE uses the DMRS and/or channel estimates from a previous slot n−1 with a DMRS of current slot n to jointly estimate the channel. However, for the first downlink slot of the burst, the receiving UE may not have the DMRS from a previous slot for combining. Furthermore, if the only DMRS is front loaded (e.g., placed in one of the first few symbols of a slot), combining with a front-loaded DMRS in the previous slot in causal cross-slot DMRS combining may lead to the extrapolation of channel estimates in the current TTI. This extrapolation may not be as accurate as interpolation, because extrapolation involves estimating an unknown value beyond the DMRSs, while interpolation involves estimating a value within the DMRSs.

In some cases, a UE may perform non-causal cross-slot DMRS combining for joint channel estimation, which involves a DMRS of a future slot. The receiving UE may wait for the next front-loaded DMRS in the next slot and perform joint channel estimation, which for the current slot n may include time interpolation. In a high mobility scenario, the selection of non-causal over causal cross-slot DMRS combining may provide an additional gain.

For non-causal DMRS cross-slot combining, a UE may expect that there is a next slot for combining, and the UE may perform DMRS detection in the next slot to decide whether to combine DMRSs. However, this could seriously delay the UE physical downlink shared channel (PDSCH) decoding timeline. That is, the UE may expect to wait for the DMRS in the next slot before completing the joint channel estimation and the PDSCH decoding. This could adversely consume the processing timing budget of the UE.

In 5G NR, repeated PUSCH transmission using multiple segments of back-to-back symbols extends PUSCH coverage without crossing the slot boundary, as each repetition segment takes different RVs. A long SLIV design may allow data channel allocation across slot boundaries while simplifying coverage extension and reducing DMRS overhead through a more uniform time-domain DMRS pattern that incorporates benefits from DMRS and CRS, especially under Doppler conditions. Additionally, reducing the time-domain density of DMRS can be achieved by exploiting groups of DMRS symbols within a channel estimation window, where the size of this window depends on the UE buffer constraint, potentially leading to overlapping sliding channel estimation windows (e.g., fluid SLIV).

In a fluid SLIV design, DMRS may be uniformly distributed over time to minimize overhead (e.g., across different SLIVs), allowing the gNB to make dynamic scheduling decisions. Although this design may include pre-committed scheduling, it may increase the likelihood of the network scheduling UEs back-to-back with the same precoder (e.g., for bursty traffic), since there's little need to change precoders initially due to low SRS transmission or CSI report duty cycles. By jointly exploiting DMRS in different SLIVs, DMRS overhead and performance can be optimized, with combinable DMRS resources in adjacent TTIs indicated to the UE for cross-SLIV combining, reducing overhead and simplifying intra-UE sharing (e.g., and inter-UE scenarios).

For a slot where the cross slot DMRS is possible and enabled, a sparser DMRS time pattern may be configured to reduce the DMRS overhead. For reception of a burst of PxSCH (e.g., PDSCH or PUSCH) transmissions, the receiver may be instructed to buffer DMRS and/or channel estimation in the earlier SLIVs for DMRS combining in the later SLIVs/slots. In such cases, the later the SLIV/slot is, the more filtering or combining the receiver may perform to improve the channel estimation quality (e.g., up to a certain degree as the channel changes eventually). Hence, the network (e.g., a gNB) may schedule a sparser DMRS time pattern for later SLIVs/slots. However, cross SLIV causal combining may not be possible, and thus, a denser DMRS pattern may be needed for the first SLIV/slot in a burst. Thus, there may be a conflict between preferred DMRS densities during different time intervals. For example, a preferred DMRS density during a first time interval (e.g., the first SLIV/slot in a burst) may be in conflict with a preferred DMRS density during a second time interval (e.g., later SLIVs/slots).

Aspects of the present disclosure, however, provide techniques for signaling, configuring, and utilizing time-varying DMRS patterns (e.g., different time domain DMRS density in different time intervals/slots/SLIV) for cross SLIV/slot DMRS combining/filtering to support DMRS sharing/combining. Utilization of the techniques disclosed herein may resolve the conflict between preferred DMRS densities during different time intervals, reducing latency and improving overall quality of experience (QoE).

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

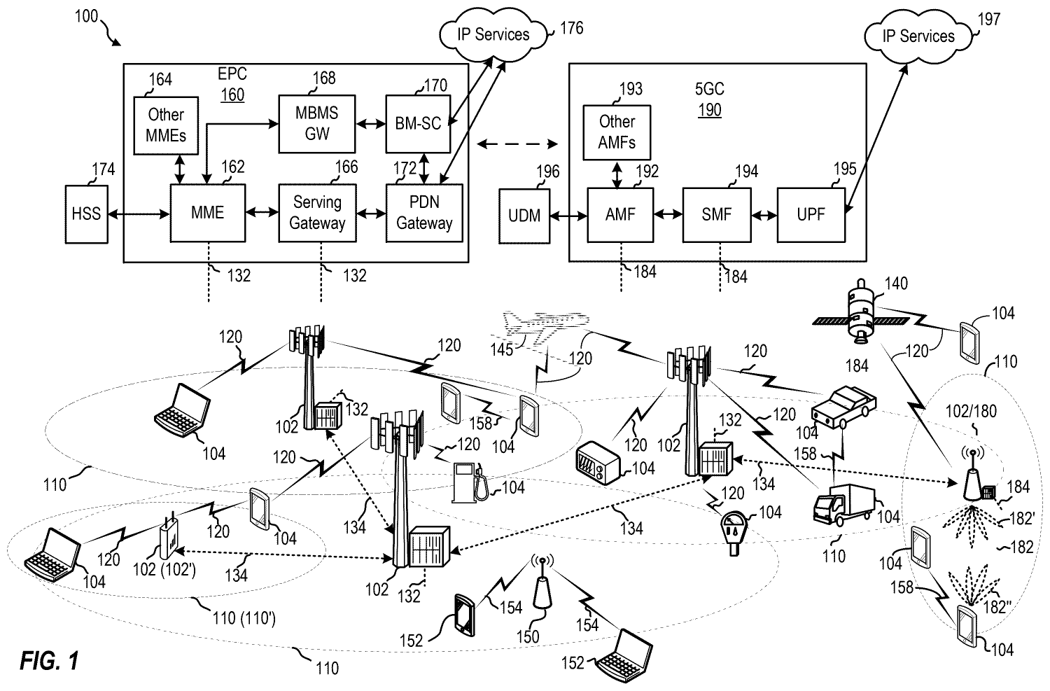

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

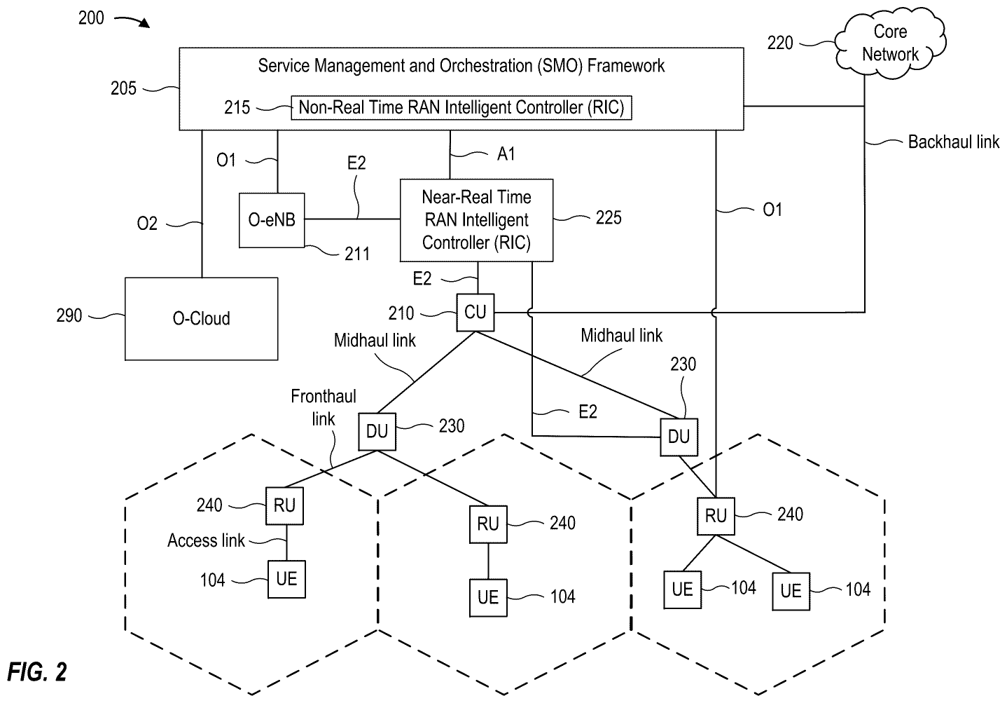

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit—User Plane (CU-UP)), control plane functionality (e.g., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

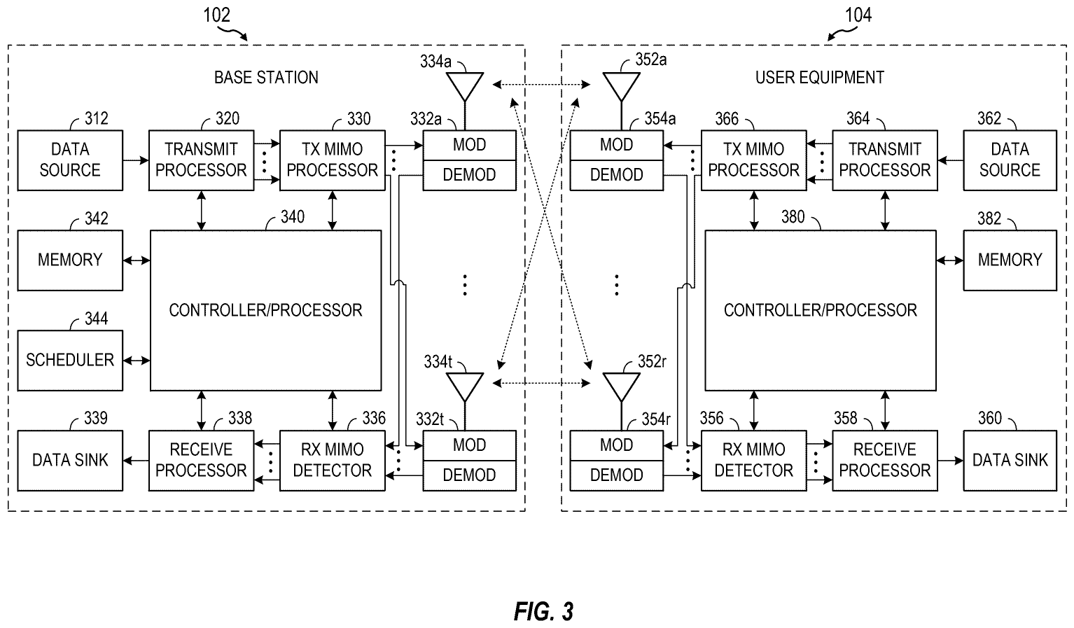

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

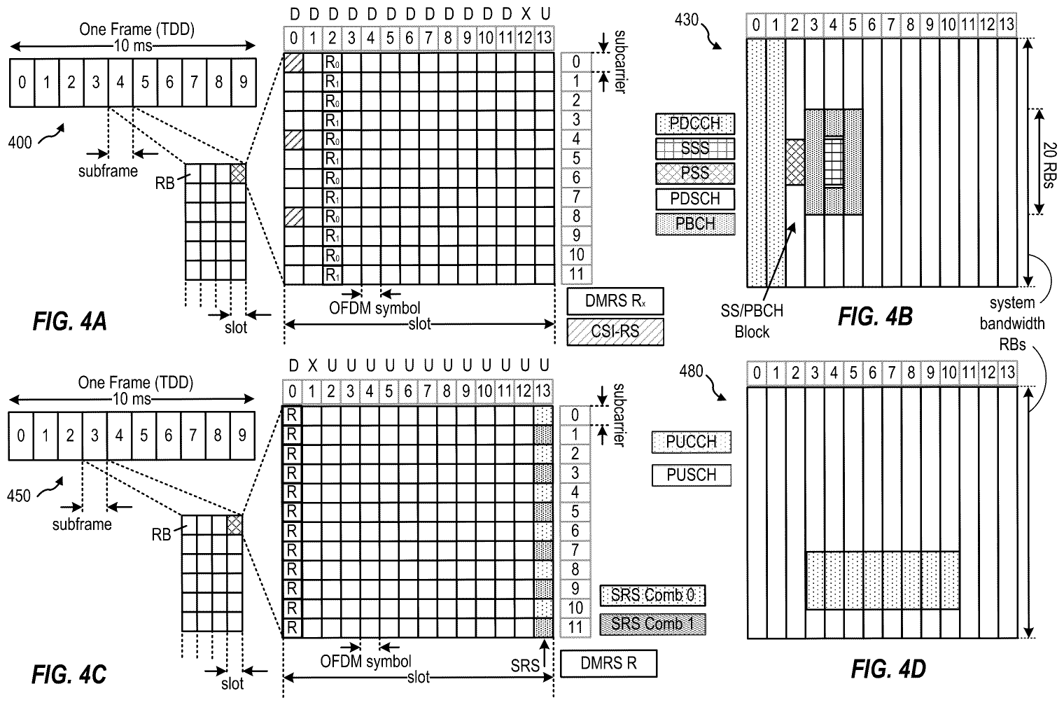

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2p slots/subframe. The subcarrier spacing and symbol length/duration are a function of the numerology. The subcarrier spacing may be equal to 2^{μ}×15 kHz, where μ is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Overview of Causal and Non-Causal Cross-Slot Combining

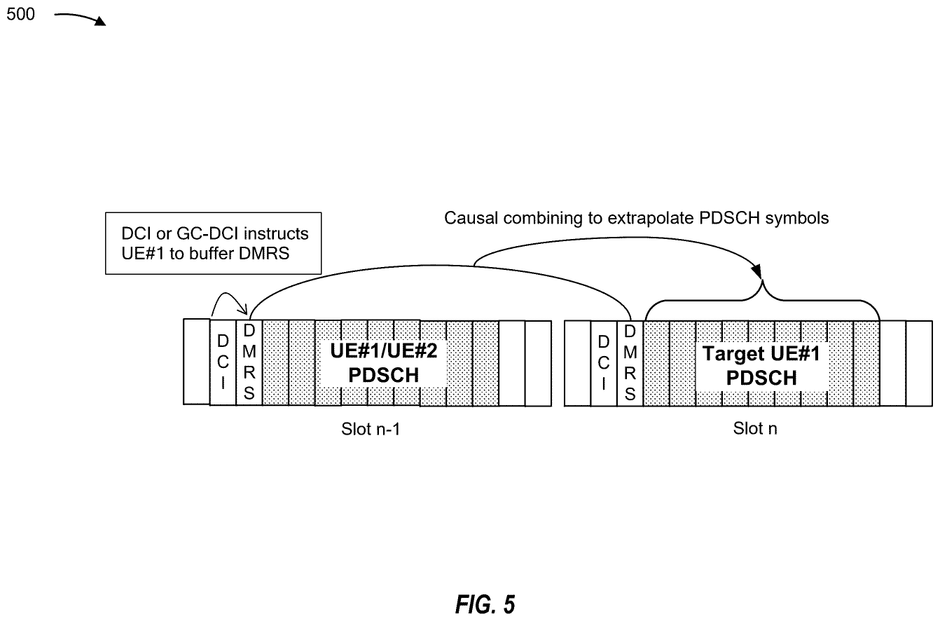

FIG. 5 is a diagram illustrating an example 500 of causal cross-slot combining. A UE may measure a DMRS in a downlink message to estimate a channel. The UE may obtain a more accurate channel estimate if the DMRS is jointly estimated with another DMRS of another TTI. In some cases, the UE may use causal cross-slot DMRS combining for channel estimation, in which the UE buffers the DMRS and/or channel estimates from a previous slot n−1 and uses the previous DMRS and/or channel estimates and a DMRS of current slot n to jointly estimate the channel. Example 500 shows cross-slot DMRS combining, where the joint channel estimation is based on combining DMRSs across slots. The combining is considered “causal” because the combining involves a past DMRS. Causal cross-slot DMRS combining may save DMRS overhead in a mobility scenario in which a network entity can allocate one DMRS while asking the UE to exploit the DMRS from previous slots.

However, for the first downlink slot of the burst, the receiving UE may not have the DMRS from a previous slot for combining. Furthermore, if the only DMRS is front loaded (e.g., placed in one of the first few symbols of a slot), combining with a front-loaded DMRS in the previous slot in causal cross-slot DMRS combining may lead to the extrapolation of channel estimates in the current TTI. This extrapolation may not be as accurate as interpolation, because extrapolation involves estimating an unknown value beyond the DMRSs, while interpolation involves estimating a value within the DMRSs.

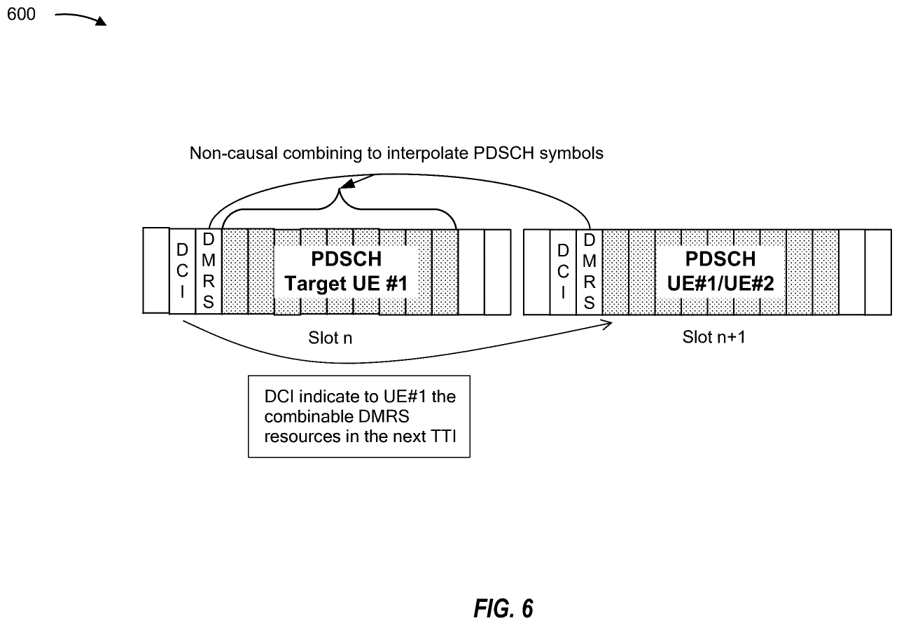

FIG. 6 is a diagram illustrating an example 600 of non-causal cross-slot combining. In some cases, a UE may perform non-causal cross-slot DMRS combining for joint channel estimation, which involves a DMRS of a future TTI (future slot). Example 600 shows that the receiving UE may wait for the next front-loaded DMRS in the next TTI (slot n+1) and perform joint channel estimation, which for the current TTI (slot n) may include time interpolation. In a high mobility scenario, with a configuration of one DMRS per slot (overhead saving), the cross-slot DMRS combining may provide substantial gains. The placement of DMRS or the selection of non-causal over causal cross-slot DMRS combining for time domain interpolation may offer an additional 10% throughput gain over extrapolation. FIG. 5 shows extrapolation of PDSCH symbols (beyond the DMRSs), and FIG. 6 shows interpolation of PDSCH symbols (between the DMRSs).

For non-causal DMRS cross slot combining, a UE may expect that there is a next slot for combining, and the UE may perform DMRS detection in the next slot to decide whether to combine DMRSs. However, this could seriously delay the UE PDSCH decoding timeline. That is, the UE may expect to wait for the DMRS in the next slot before completing the joint channel estimation and the PDSCH decoding. This could adversely consume the processing time budget of the UE that is part of the processing time K1, especially for a multi-carrier case or a 400 megahertz (MHz) case.

In some cases, to combine the DMRS in the next slot for joint channel estimation, the receiving UE may expect a combinable DMRS in the next slot, and the actual cross-slot DMRS combining may be based on the DMRS/DCI detection in the next slot. The UE may have to delay the channel estimation and hence delay PDSCH decoding after receiving at least the first DMRS in the next slot. To avoid the case in which the UE always waits until the next slot for PDSCH decoding, some network entity signaling can be introduced. In some cases, a network entity may indicate whether non-causal DMRS cross-slot combining is possible with the next TTI (e.g., next slot). The network entity may also indicate combinable DMRS resources in the next slot. If the network entity indicates that cross-slot DMRS combining is possible, the network entity may commit to scheduling the next slot with the same precoding and/or the same TCI state.

In some cases, the network entity may provide an indication (e.g., in DCI) of whether non-causal DMRS cross-slot combining is possible in a next slot. The DCI may further indicate a port number, an FDRA, and/or which DMRS symbols in the next slot are combinable for non-causal cross-slot DMRS combining. Based at least in part on the indication, the UE may decide whether to delay the channel estimation, delay a PDSCH demapper (that demaps symbols to bits), and/or to delay a decoding timeline. By indicating whether DMRS combining is possible, the UE may perform joint channel estimation with cross-slot DMRS combining only when doing so is worth the use of the resources. As a result, latency is reduced and/or the UE processing timeline is not negatively impacted.

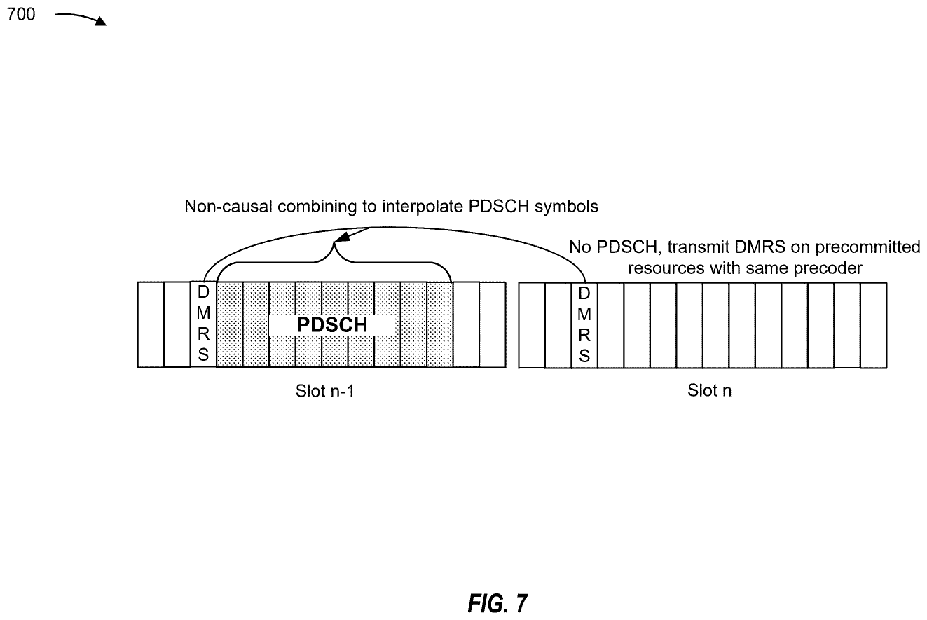

FIG. 7 is a diagram illustrating an example 700 of non-causal cross-slot combining. In some cases, for the next slot, the network entity may determine to transmit or not transmit based at least in part on the traffic. If the network entity determines to transmit a PDSCH message, the network entity may conform to a pre-committed precoder and DMRS resources such that the UE may perform non-causal cross-slot DMRS combining. If the network entity has no PDSCH message to transmit, for the next slot, the network entity may refrain from transmitting anything, and the UE may determine to perform cross-slot channel estimation based at least in part on blind DCI detection or blind DMRS detection in the next slot. Based at least in part on the DMRS detection or the DCI detection, the UE may determine whether to perform cross-slot channel estimation or a single slot legacy channel estimation.

In some cases, for the next slot, even if the network entity has no PDSCH message to transmit, the UE may still transmit the DMRS that is pre-committed in the previous DCI, as shown by example 700. With the standalone DMRS, the UE may have DMRSs to combine in the next slot regardless of whether the network entity has transmitted a PDSCH message.

In some cases, if the network entity determines to change a precoder for the next slot (performing MU-MIMO) or change an FDRA for frequency division multiplexing (FDMing) UEs, and if the UE blindly combines with the next slot, this can degrade channel estimation performance. In some cases, the network entity may transmit DCI in the next slot to indicate that non-causal cross-slot DMRS combining is canceled. The UE may have to read the DCI to know that the DMRS combining is cancelled.

In some cases, the UE may determine whether to combine DMRSs based at least in part on the DMRS detection in the next slot, because DCI detection may take more time. In such cases, the UE may select a different DMRS scrambling sequence for the next slot if the network entity determines to cancel the combining. In some cases, in NR, the network entity may determine two different DMRS initial seeds and signal a DMRS sequence initialization field in DCI. The network entity may signal a DMRS sequence initialization field if the UE determines to change the precoder in the next slot.

### Aspects Related to DMRS Patterns for Cross-SLIV/Slot Combining

As noted above, there may be a conflict between preferred DMRS densities during different time intervals. For example, a preferred DMRS density during a first time interval (e.g., the first SLIV/slot in a burst) may be in conflict with a preferred DMRS density during a second time interval (e.g., later SLIVs/slots).

Aspects of the present disclosure, however, provide techniques for signaling, configuring, and utilizing time-varying DMRS patterns (e.g., different time domain DMRS density in different time intervals/slots/SLIV) for cross SLIV/slot DMRS combining/filtering to support DMRS sharing/combining.

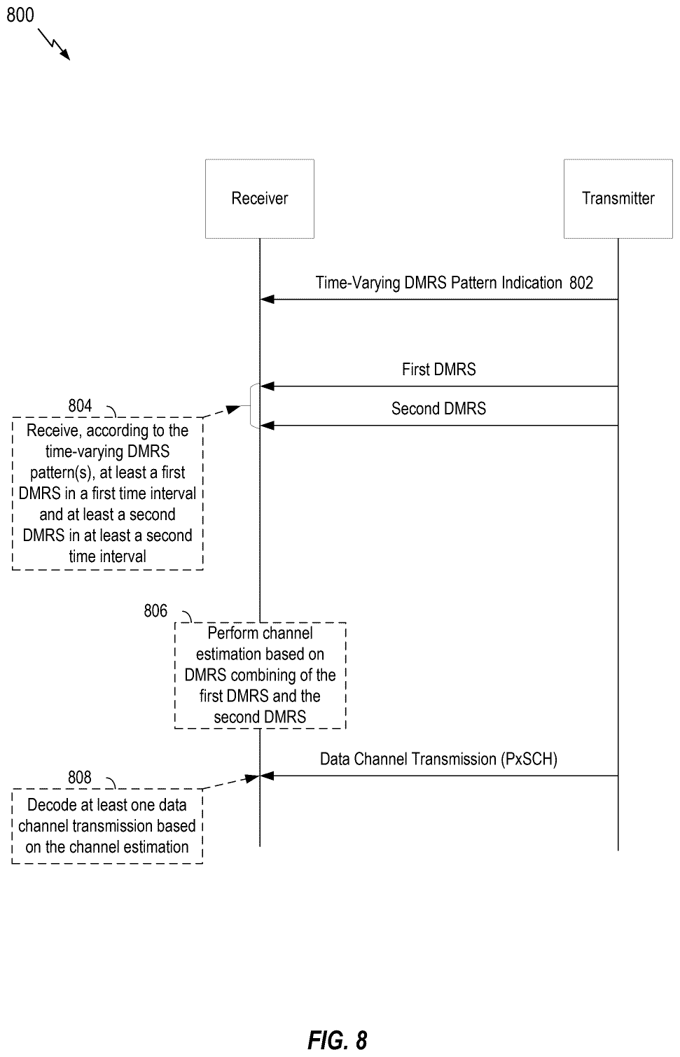

These techniques may be understood with reference to FIG. 8, which depicts a call flow diagram 800, in accordance with aspects of the present disclosure. In some aspects, the receiver may be an example of the BS 102 or the UE 104 depicted and described with respect to FIGS. 1 and 3 or a disaggregated base station depicted and described with respect to FIG. 2. Similarly, the transmitter may be an example of the BS 102 or the UE 104 depicted and described with respect to FIGS. 1 and 3 or a disaggregated base station depicted and described with respect to FIG. 2. However, in other aspects, the receiver and/or the transmitter may be another type of wireless communications device, or another type of network entity or network node, such as those described herein.

As illustrated at 802, a receiver device may receive an indication of a time-varying DMRS pattern (e.g., having a first DMRS density for a first time interval and a second DMRS density for a second time interval). As illustrated at 804, the receiver may receive a first DMRS in a first time interval and at least a second DMRS in at least a second time interval, according to the time-varying DMRS pattern.

As illustrated at 806, the receiver may perform channel estimation based on DMRS combining of the first DMRS and the second DMRS. In some aspects, the channel estimation may be based on causal and/or non-causal DMRS combining.

As illustrated at 808, the receiver may receive and decode at least one data channel transmission (e.g., a PDSCH or PUSCH) based on the channel estimation.

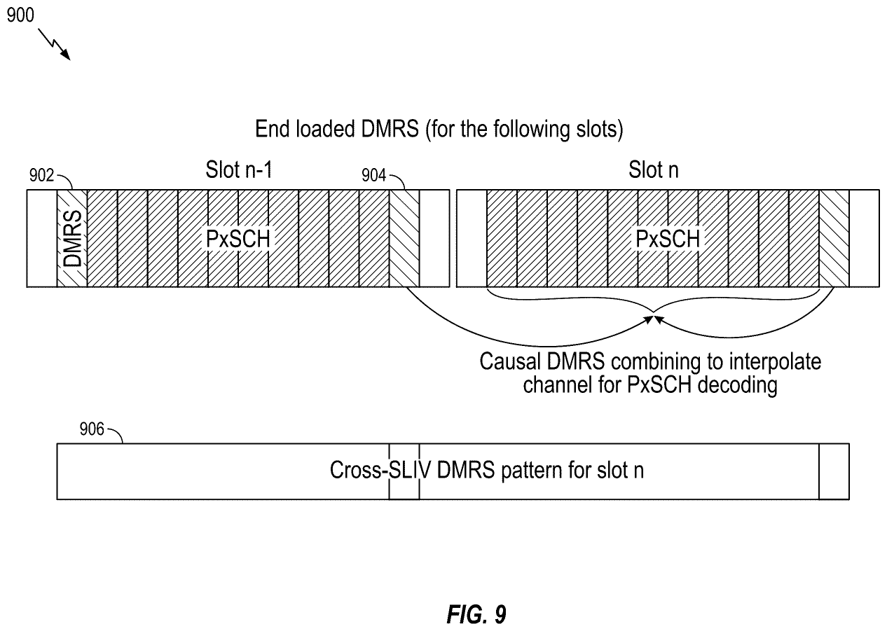

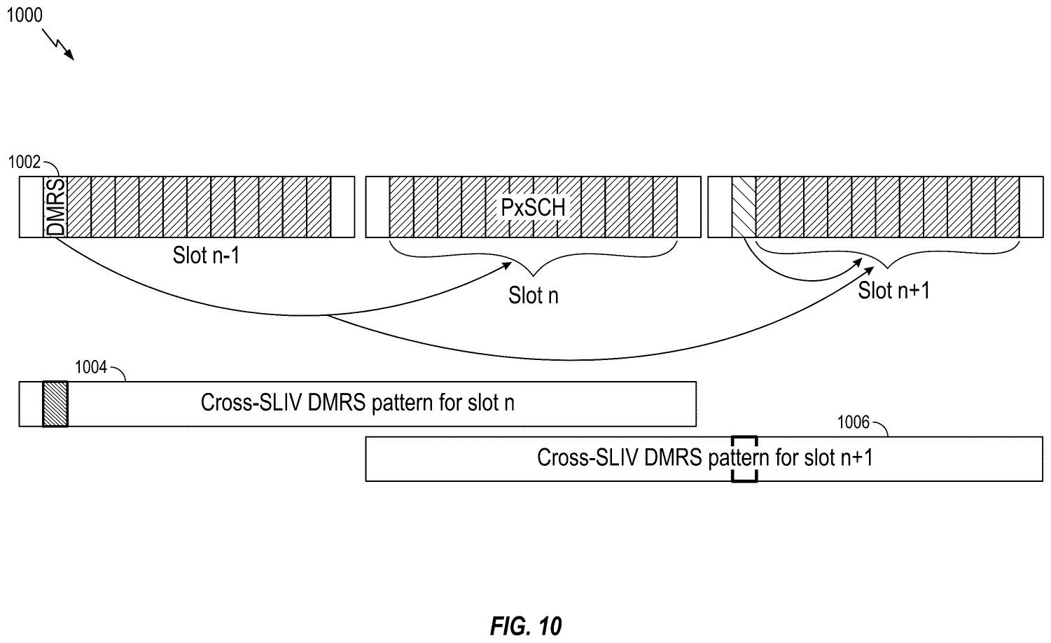

In some aspects, a receiver (e.g., of a PxSCH data transmission) may be instructed/configured and/or may plan to buffer DMRS/channel estimation in earlier SLIVs/slots for DMRS combining in later SLIVs/slots. In such cases, the receiver may perform more DMRS filtering or combining for the later SLIVs. Thus, the network (e.g., a gNB) may schedule end-loaded DMRS pattern(s) having fewer DMRS symbols for the later SLIVs/slots (e.g., as illustrated and described below with respect to FIG. 9) or even no DMRS symbol in some of the later SLIVs/slots (e.g., as illustrated and described below with respect to FIG. 10). This may be advantageous because DMRS symbol(s) in the previous SLIV(s) may be exploited for interpolating the channel for the earlier part of the later SLIV. For the first SLIV/slot, cross-SLIV causal combining may not be possible, and thus, an SLIV-contained DMRS pattern may be needed.

In some aspects, a receiver (e.g., of a PxSCH data transmission) may be instructed/configured and/or may plan to perform causal DMRS combining across SLIVs. In such cases, the earliest SLIV(s) may have an SLIV-contained DMRS pattern, and the following SLIVs may have cross-SLIV DMRS pattern(s) (e.g., with less DMRS overhead). The SLIV-contained DMRS pattern may be a denser DMRS pattern, which may allow the receiver to perform per SLIV channel estimation for the earlier SLIV where cross-slot combining is not possible. The cross-SLIV DMRS pattern may be defined for later SLIVs/slots where causal DMRS combining is possible. The cross-SLIV DMRS pattern may be defined over a number of previously transmitted slots and the current slot(s) with DMRS symbols pre-committed by earlier PxSCH transmission.

FIG. 9 depicts an example 900 of a cross start and length indicator value (SLIV) demodulation reference signal (DMRS) pattern for causal DMRS combining, in accordance with aspects of the present disclosure.

As illustrated, the first slot n−1 has an SLIV-contained DMRS pattern with two DMRS 902 and 904 (front and rear loaded), which allows the receiver to reliably decode the PxSCH. For the later slots where causal DMRS combining (with one slot earlier) is triggered, cross-SLIV DMRS pattern(s) over current and previous slots may be used. For the cross-SLIV DMRS pattern 906, the DMRS symbols in the previous slots may be predetermined, and end-loaded DMRS may be used in the current slot n, as illustrated. As illustrated, causal DMRS combining may be performed to interpolate the channel for PxSCH decoding for slot n.

FIG. 10 depicts an example 1000 of a cross-SLIV DMRS pattern for causal DMRS combining, in accordance with aspects of the present disclosure.

As illustrated, the first slot n−1 has an SLIV-contained DMRS pattern with one front-loaded DMRS 1002, which allows the receiver to reliably decode the PxSCH. For the later slots where causal DMRS combining (with one slot earlier) is triggered, cross-SLIV DMRS pattern(s) 1004 and 1006 over current and previous slots may be used. For the later slots where the preceding slot has one front loaded DMRS, the cross-SLIV DMRS pattern 1004 may only include the DMRS in the previous slot. For the later slot(s) where the preceding slot has no DMRS or no proceeding slot, the cross-SLIV DMRS pattern 1006 may only include a front loaded DMRS in a current slot.

In some aspects, a receiver (e.g., of a PxSCH data transmission) may be instructed/configured and/or may plan to perform non-causal DMRS combining across SLIVs (e.g., wait for the DMRS in the next slot for the DMRS combining before decoding the PxSCH in the current slot). For a given data burst of N slots, non-causal combining may be possible for the first N−1 slots. Thus, a front loaded DMRS pattern with a fewer total quantity of DMRS symbols may be preferred (e.g., more advantageous).

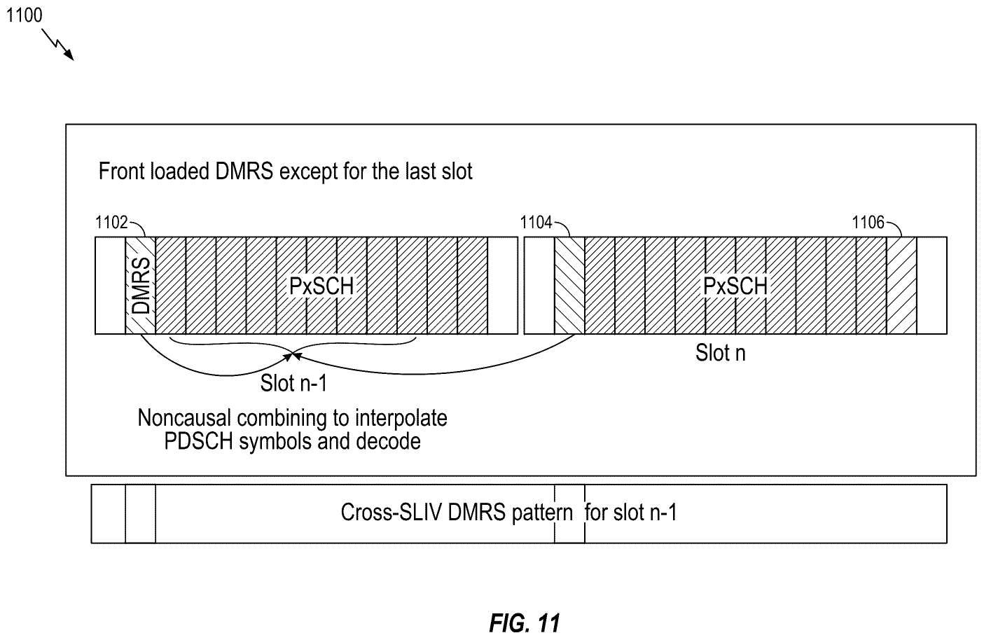

In some aspects, a receiver (e.g., of a PxSCH data transmission) may be instructed/configured and/or may plan to perform non-causal DMRS combining across SLIVs. In such cases, the last SLIV(s) may have an SLIV-contained DMRS pattern, and the earlier SLIVs (where non-causal DMRS combining is possible) may have a cross-SLIV DMRS pattern (e.g., with less DMRS overhead). An example of this is illustrated with respect to FIG. 11, which depicts an example 1100 of a cross-SLIV DMRS pattern for non-causal DMRS combining, in accordance with aspects of the present disclosure.

As illustrated, a front loaded DMRS 1102 is configured for the beginning SLIV/slot n−1 (e.g., cross-SLIV DMRS pattern with front loaded DMRS in the current slot and the following slot), and 2 DMRS 1104/1106 (front and rear loaded) are configured for the last slot n for a slot-contained channel estimation (e.g., where non-causal DMRS combining with DMRS in later slots is possible). As illustrated, noncausal combining may be performed to interpolate PxSCH symbols and decode for slot n−1.

In some aspects, a multi-TTI grant may schedule multiple SLIVs/slots, and may schedule adaptive DMRS pattern(s). For example, in some aspects, multiple sets of (e.g., combinations of) cross-SLIV DMRS pattern(s) may be defined. In such cases, the multi-TTI grant may signal which set of cross-SLIV DMRS pattern(s) to use. For example, RRC signaling may configure multiple slot/SLIV varying DMRS patterns with a combination of different cross-SLIV DMRS patterns. Based on the Doppler frequency and the UE's capability to perform DMRS combining, the DCI may indicate the pattern index of the slot/SLIV varying DMRS pattern.

In some aspects, RRC signaling may configure multiple cross-SLIV DMRS pattern(s), and the multi-TTI grant may indicate the cross-SLIV DMRS pattern for each scheduled slot/SLIV. In such cases, the DCI overhead for DMRS pattern indication may be proportional to the quantity of cross-SLIV patterns scheduled (e.g., which may be relatively large).

In some cases, RRC signaling may be used to configure multiple cross-SLIV DMRS pattern(s), and each DCI may indicate the cross-SLIV DMRS pattern for each scheduled slot/SLIV. In certain DMRS combining designs, a DCI scheduling a data transmission (e.g., PDSCH) may also indicate the UE to perform cross SLIV/slot DMRS combining (e.g., causal/non-causal). Depending on whether the DCI indicates cross SLIV/slot DMRS combining or not, different DMRS time pattern may be used.

In some aspects, RRC signaling may be used to configure separate DMRS patterns for non-cross SLIV/slot (e.g., SLIV contained) and cross SLIV/slot DMRS combining slots. In such cases, the DMRS pattern may be determined based on the X-slot/SLIV DMRS combining trigger. If the X-slot combining is triggered, then the cross-SLIV DMRS pattern(s) may be used. Otherwise, the SLIV contained DMRS pattern may be used.

In some aspects, for causal DMRS combining, DCI (e.g., previously transmitted DCI) may also request the UE to buffer DMRS and channel estimation for the final causal DMRS combining. In such cases, depending on the quantity of DMRS symbols that are in the receiver UE's combining buffer (e.g., depending on how many DMRS and/or channel estimation buffering requests are sent over the air, a combining time span, and/or the UE's capability), the DMRS time pattern may be adjusted accordingly.

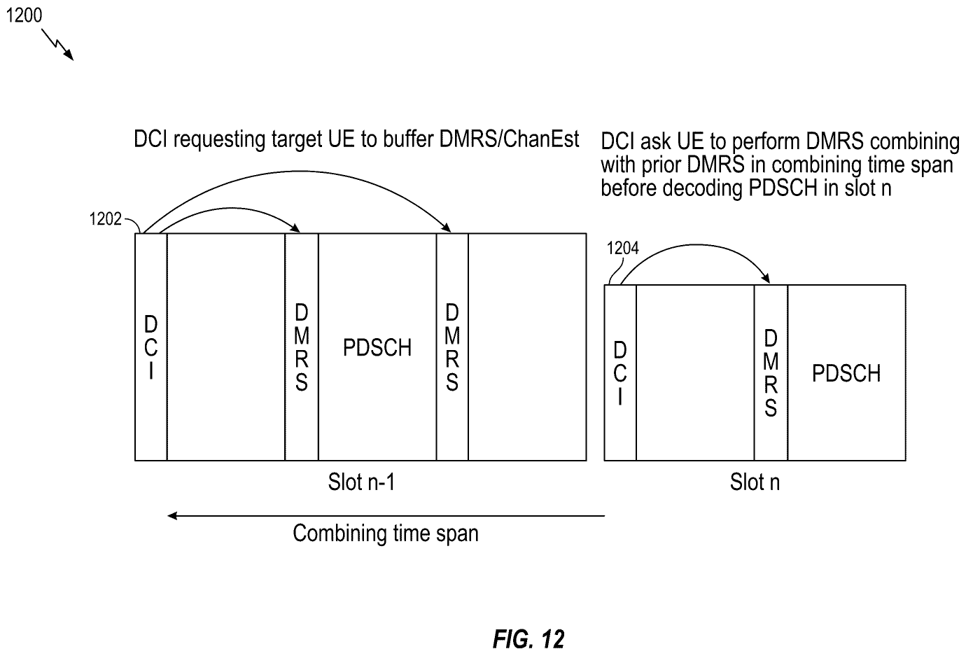

In some aspects, different DMRS patterns for non-cross and cross SLIV/slot DMRS combining slots may be RRC configured. This may be understood with reference to FIG. 12, which depicts an example 1200 of signaling for a time varying DMRS pattern in a per-SLIV grant.

As illustrated, a first DCI 1202 may request a UE to buffer DMRS and channel estimation (e.g., for DMRS combining). A second DCI 1204 associated with slot n may request the UE to perform DMRS combining with prior DMRS in a particular time duration (e.g., a combining time span) before decoding PDSCH in slot n. A particular DMRS pattern may be determined based on the X-slot/SLIV DMRS combining triggering, and a cross-SLIV DMRS pattern may be determined based on a quantity and a location of DMRS symbols from prior slots that are expected to be within the combining time span.

In such cases, the receiver may determine the cross-SLIV DMRS pattern based on a quantity and a location of DMRS symbol(s) in the combining time span and whether or not causal cross slot/SLIV combining is enabled. In some cases, the quantity of DMRS in the combining time span (as determined at the receiver UE) may be inaccurate (e.g., if the UE misses any DMRS buffering grant).

Utilization of the techniques disclosed herein may resolve the conflict between preferred DMRS densities during different time intervals, reducing latency and improving overall quality of experience (QoE).

### Example Operations

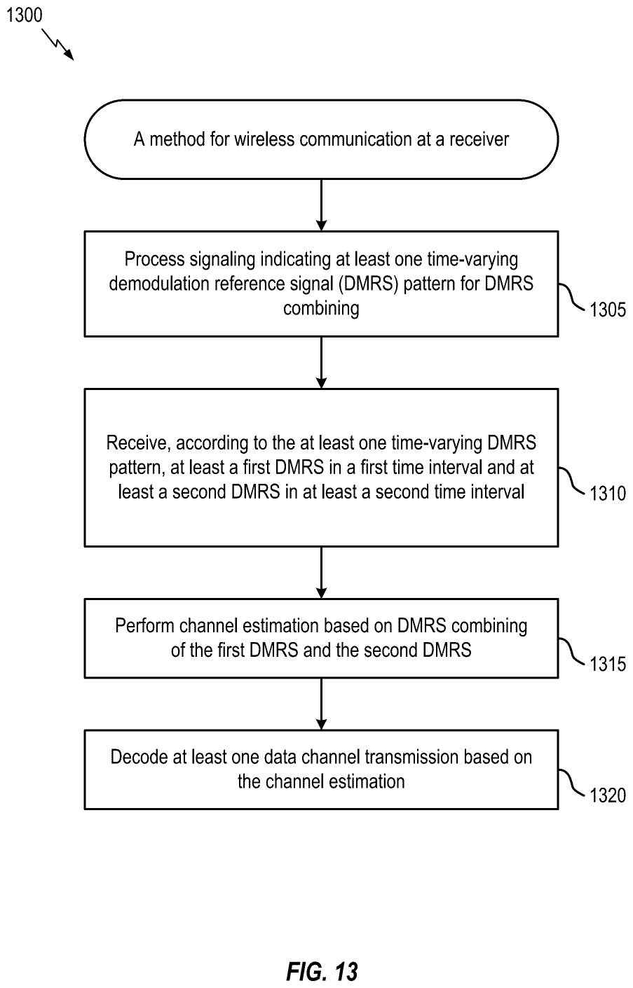

FIG. 13 shows an example of a method 1300 of wireless communication at a receiver. In some examples, the receiver is a user equipment, such as a UE 104 of FIGS. 1 and 3. In some examples, the receiver is a network entity, such as a BS 102 of FIGS. 1 and 3, or a disaggregated base station as discussed with respect to FIG. 2.

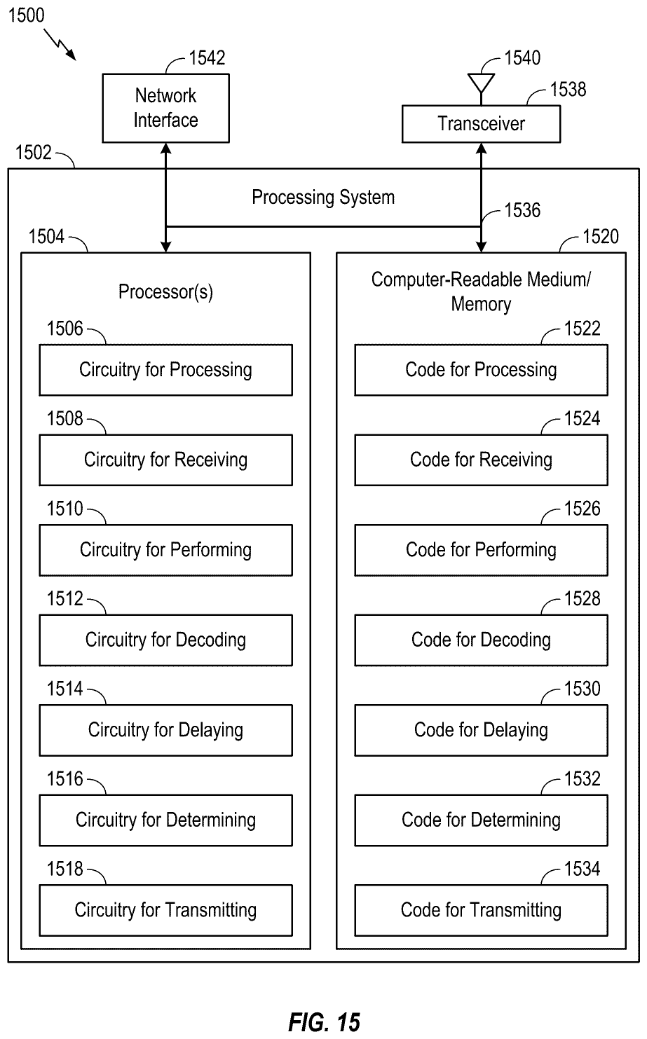

Method 1300 begins at step 1305 with processing signaling indicating at least one time-varying demodulation reference signal (DMRS) pattern for DMRS combining. In some cases, the operations of this step refer to, or may be performed by, circuitry for processing and/or code for processing as described with reference to FIG. 15.

Method 1300 then proceeds to step 1310 with receiving, according to the at least one time-varying DMRS pattern, at least a first DMRS in a first time interval and at least a second DMRS in at least a second time interval. In some cases, the operations of this step refer to, or may be performed by, circuitry for receiving and/or code for receiving as described with reference to FIG. 15.

Method 1300 then proceeds to step 1315 with performing channel estimation based on DMRS combining of the first DMRS and the second DMRS. In some cases, the operations of this step refer to, or may be performed by, circuitry for performing and/or code for performing as described with reference to FIG. 15.

Method 1300 then proceeds to step 1320 with decoding at least one data channel transmission based on the channel estimation. In some cases, the operations of this step refer to, or may be performed by, circuitry for decoding and/or code for decoding as described with reference to FIG. 15.

In some aspects, the at least one time-varying DMRS pattern indicates a first DMRS density for the first time interval and at least a second DMRS density for the at least the second time interval.

In some aspects, the first time interval comprises a first slot and the at least the second time interval comprises at least a second slot.

In some aspects, the first time interval is defined by a first Start and Length Indicator Value (SLIV) and the second time interval is defined by a second SLIV.

In some aspects, the data channel transmission comprises at least one of: a physical downlink shared channel (PDSCH) transmission, or a physical uplink shared channel (PUSCH) transmission.

In some aspects, the at least one time-varying DMRS pattern is indicated by at least one of: radio resource control (RRC) signaling, or downlink control information (DCI).

In some aspects, the second time interval occurs temporally after the first time interval.

In some aspects, performing the channel estimation comprises: averaging measurements of DMRS tones from the second time interval with stored measurements of DMRS tones from the first time interval; and estimating channel characteristics for the second time interval based on the averaged measurements.

In some aspects, the method 1300 further includes delaying decoding a data channel transmission for the first time interval until after reception of the at least the second DMRS. In some cases, the operations of this step refer to, or may be performed by, circuitry for delaying and/or code for delaying as described with reference to FIG. 15.

In some aspects, performing the channel estimation comprises; averaging measurements of DMRS tones from the first time interval with measurements of DMRS tones of the at least the second DMRS; and estimating channel characteristics for the first time interval based on the averaged measurements.

In some aspects, the signaling comprises: first signaling defining a set of time varying DMRS patterns; and second signaling indicating a time varying DMRS pattern, from the set of time varying DMRS patterns, for DMRS combining.

In some aspects, the first signaling comprises radio resource control (RRC) signaling; and the second signaling comprises downlink control information (DCI).

In some aspects, the first signaling indicates at least a first DMRS pattern for use when DMRS combining is enabled and at least a second DMRS pattern for use when DMRS combining is disabled; and the second signaling indicates whether DMRS combining is enabled or disabled.

In some aspects, the signaling indicates a quantity of DMRS symbols from one or more time intervals to be combined when performing the channel estimation.

In some aspects, the method 1300 further includes determining the at least one time-varying DMRS pattern based on the indicated quantity. In some cases, the operations of this step refer to, or may be performed by, circuitry for determining and/or code for determining as described with reference to FIG. 15.

In some aspects, the receiver comprises a user equipment (UE); and the processing comprises receiving the signaling.

In some aspects, the receiver comprises a network entity; and the processing comprises transmitting the signaling.

In one aspect, method 1300, or any aspect related to it, may be performed by an apparatus, such as communications device 1500 of FIG. 15, which includes various components operable, configured, or adapted to perform the method 1300. Communications device 1500 is described below in further detail.

Note that FIG. 13 is just one example of a method, and other methods including fewer, additional, or alternative steps are possible consistent with this disclosure.

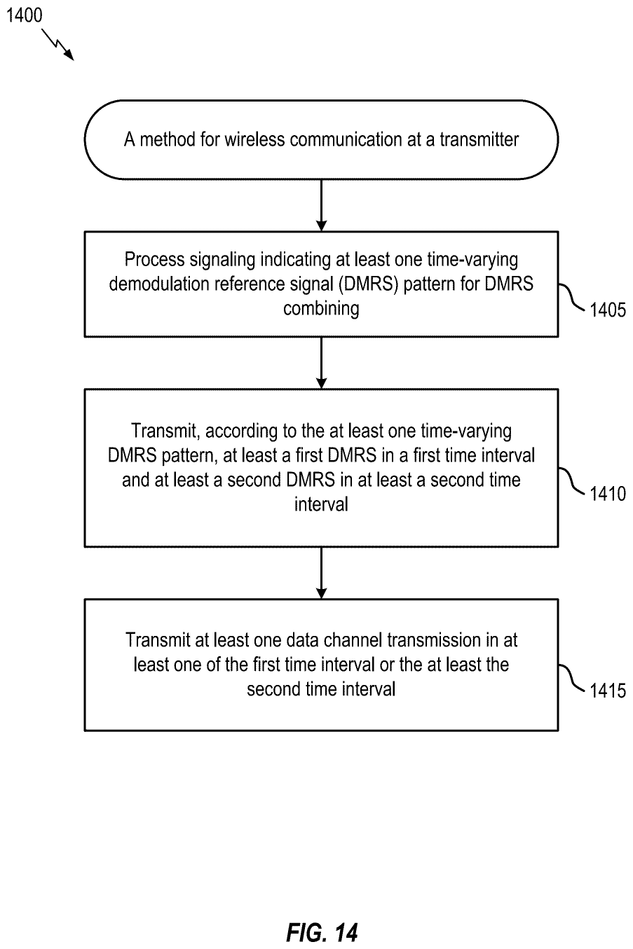

FIG. 14 shows an example of a method 1400 of wireless communication at a transmitter. In some examples, the transmitter is a user equipment, such as a UE 104 of FIGS. 1 and 3. In some examples, the transmitter is a network entity, such as a BS 102 of FIGS. 1 and 3, or a disaggregated base station as discussed with respect to FIG. 2.

Method 1400 begins at step 1405 with processing signaling indicating at least one time-varying demodulation reference signal (DMRS) pattern for DMRS combining. In some cases, the operations of this step refer to, or may be performed by, circuitry for processing and/or code for processing as described with reference to FIG. 15.

Method 1400 then proceeds to step 1410 with transmitting, according to the at least one time-varying DMRS pattern, at least a first DMRS in a first time interval and at least a second DMRS in at least a second time interval. In some cases, the operations of this step refer to, or may be performed by, circuitry for transmitting and/or code for transmitting as described with reference to FIG. 15.

Method 1400 then proceeds to step 1415 with transmitting at least one data channel transmission in at least one of the first time interval or the at least the second time interval. In some cases, the operations of this step refer to, or may be performed by, circuitry for transmitting and/or code for transmitting as described with reference to FIG. 15.

In some aspects, the at least one time-varying DMRS pattern indicates a first DMRS density for the first time interval and at least a second DMRS density for the at least the second time interval.

In some aspects, the first time interval comprises a first slot and the at least the second time interval comprises at least a second slot.

In some aspects, the first time interval is defined by a first Start and Length Indicator Value (SLIV) and the second time interval is defined by a second SLIV.

In some aspects, the data channel transmission comprises at least one of: a physical downlink shared channel (PDSCH) transmission, or a physical uplink shared channel (PUSCH) transmission.

In some aspects, the at least one time-varying DMRS pattern is indicated by at least one of: radio resource control (RRC) signaling, or downlink control information (DCI).

In some aspects, the second time interval occurs temporally after the first time interval.

In some aspects, the signaling comprises: first signaling defining a set of time varying DMRS patterns; and second signaling indicating a time varying DMRS pattern, from the set of time varying DMRS patterns, for DMRS combining.

In some aspects, the first signaling comprises radio resource control (RRC) signaling; and the second signaling comprises downlink control information (DCI).

In some aspects, the first signaling indicates at least a first DMRS pattern for use when DMRS combining is enabled and at least a second DMRS pattern for use when DMRS combining is disabled; and the second signaling indicates whether DMRS combining is enabled or disabled.

In some aspects, the signaling indicates a quantity of DMRS symbols from one or more time intervals to be combined when performing channel estimation.

In some aspects, the transmitter comprises a user equipment (UE); and the processing comprises receiving the signaling.

In some aspects, the transmitter comprises a network entity; and the processing comprises transmitting the signaling.

In one aspect, method 1400, or any aspect related to it, may be performed by an apparatus, such as communications device 1500 of FIG. 15, which includes various components operable, configured, or adapted to perform the method 1400.

Communications device 1500 is described below in further detail.

Note that FIG. 14 is just one example of a method, and other methods including fewer, additional, or alternative steps are possible consistent with this disclosure.

### Example Communications Device(s)

FIG. 15 depicts aspects of an example communications device 1500. In some aspects, communications device 1500 is a user equipment, such as UE 104 described above with respect to FIGS. 1 and 3. In some aspects, communications device 1500 is a network entity, such as BS 102 of FIGS. 1 and 3, or a disaggregated base station as discussed with respect to FIG. 2.

The communications device 1500 includes a processing system 1502 coupled to the transceiver 1538 (e.g., a transmitter and/or a receiver). In some aspects (e.g., when communications device 1500 is a network entity), processing system 1502 may be coupled to a network interface 1542 that is configured to obtain and send signals for the communications device 1500 via communication link(s), such as a backhaul link, midhaul link, and/or fronthaul link as described herein, such as with respect to FIG. 2. The transceiver 1538 is configured to transmit and receive signals for the communications device 1500 via the antenna 1540, such as the various signals as described herein. The processing system 1502 may be configured to perform processing functions for the communications device 1500, including processing signals received and/or to be transmitted by the communications device 1500.

The processing system 1502 includes one or more processors 1504. In various aspects, the one or more processors 1504 may be representative of one or more of receive processor 358, transmit processor 364, TX MIMO processor 366, and/or controller/processor 380, as described with respect to FIG. 3. In various aspects, one or more processors 1504 may be representative of one or more of receive processor 338, transmit processor 320, TX MIMO processor 330, and/or controller/processor 340, as described with respect to FIG. 3. The one or more processors 1504 are coupled to a computer-readable medium/memory 1520 via a bus 1536. In certain aspects, the computer-readable medium/memory 1520 is configured to store instructions (e.g., computer-executable code) that when executed by the one or more processors 1504, cause the one or more processors 1504 to perform the method 1300 described with respect to FIG. 13, or any aspect related to it; and the method 1400 described with respect to FIG. 14, or any aspect related to it. Note that reference to a processor performing a function of communications device 1500 may include one or more processors 1504 performing that function of communications device 1500.

In the depicted example, computer-readable medium/memory 1520 stores code (e.g., executable instructions), such as code for processing 1522, code for receiving 1524, code for performing 1526, code for decoding 1528, code for delaying 1530, code for determining 1532, and code for transmitting 1534. Processing of the code for processing 1522, code for receiving 1524, code for performing 1526, code for decoding 1528, code for delaying 1530, code for determining 1532, and code for transmitting 1534 may cause the communications device 1500 to perform the method 1300 described with respect to FIG. 13, or any aspect related to it; and the method 1400 described with respect to FIG. 14, or any aspect related to it.

The one or more processors 1504 include circuitry configured to implement (e.g., execute) the code stored in the computer-readable medium/memory 1520, including circuitry for processing 1506, circuitry for receiving 1508, circuitry for performing 1510, circuitry for decoding 1512, circuitry for delaying 1514, circuitry for determining 1516, and circuitry for transmitting 1518. Processing with circuitry for processing 1506, circuitry for receiving 1508, circuitry for performing 1510, circuitry for decoding 1512, circuitry for delaying 1514, circuitry for determining 1516, and circuitry for transmitting 1518 may cause the communications device 1500 to perform the method 1300 described with respect to FIG. 13, or any aspect related to it; and the method 1400 described with respect to FIG. 14, or any aspect related to it.

Various components of the communications device 1500 may provide means for performing the method 1300 described with respect to FIG. 13, or any aspect related to it; and the method 1400 described with respect to FIG. 14, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1538 and the antenna 1540 of the communications device 1500 in FIG. 15. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1538 and the antenna 1540 of the communications device 1500 in FIG. 15.

### Example Clauses

Implementation examples are described in the following numbered clauses:

Clause 1: A method for wireless communication at a receiver, comprising: processing signaling indicating at least one time-varying demodulation reference signal (DMRS) pattern for DMRS combining; receiving, according to the at least one time-varying DMRS pattern, at least a first DMRS in a first time interval and at least a second DMRS in at least a second time interval; performing channel estimation based on DMRS combining of the first DMRS and the second DMRS; and decoding at least one data channel transmission based on the channel estimation.

Clause 2: The method of Clause 1, wherein the at least one time-varying DMRS pattern indicates a first DMRS density for the first time interval and at least a second DMRS density for the at least the second time interval.

Clause 3: The method of any one of Clauses 1-2, wherein the first time interval comprises a first slot and the at least the second time interval comprises at least a second slot.

Clause 4: The method of any one of Clauses 1-3, wherein the first time interval is defined by a first Start and Length Indicator Value (SLIV) and the second time interval is defined by a second SLIV.

Clause 5: The method of any one of Clauses 1-4, wherein the data channel transmission comprises at least one of: a physical downlink shared channel (PDSCH) transmission, or a physical uplink shared channel (PUSCH) transmission.

Clause 6: The method of any one of Clauses 1-5, wherein the at least one time-varying DMRS pattern is indicated by at least one of: radio resource control (RRC) signaling, or downlink control information (DCI).

Clause 7: The method of any one of Clauses 1-6, wherein the second time interval occurs temporally after the first time interval.

Clause 8: The method of Clause 7, wherein performing the channel estimation comprises: averaging measurements of DMRS tones from the second time interval with stored measurements of DMRS tones from the first time interval; and estimating channel characteristics for the second time interval based on the averaged measurements.

Clause 9: The method of Clause 7, comprising: delaying decoding a data channel transmission for the first time interval until after reception of the at least the second DMRS.

Clause 10: The method of Clause 9, wherein performing the channel estimation comprises; averaging measurements of DMRS tones from the first time interval with measurements of DMRS tones of the at least the second DMRS; and estimating channel characteristics for the first time interval based on the averaged measurements.

Clause 11: The method of any one of Clauses 1-10, wherein the signaling comprises: first signaling defining a set of time varying DMRS patterns; and second signaling indicating a time varying DMRS pattern, from the set of time varying DMRS patterns, for DMRS combining.

Clause 12: The method of Clause 11, wherein: the first signaling comprises radio resource control (RRC) signaling; and the second signaling comprises downlink control information (DCI).

Clause 13: The method of Clause 11, wherein: the first signaling indicates at least a first DMRS pattern for use when DMRS combining is enabled and at least a second DMRS pattern for use when DMRS combining is disabled; and the second signaling indicates whether DMRS combining is enabled or disabled.

Clause 14: The method of any one of Clauses 1-13, wherein: the signaling indicates a quantity of DMRS symbols from one or more time intervals to be combined when performing the channel estimation.

Clause 15: The method of Clause 14, further comprising determining the at least one time-varying DMRS pattern based on the indicated quantity.

Clause 16: The method of any one of Clauses 1-15, wherein: the receiver comprises a user equipment (UE); and the processing comprises receiving the signaling.

Clause 17: The method of any one of Clauses 1-16, wherein: the receiver comprises a network entity; and the processing comprises transmitting the signaling.

Clause 18: A method for wireless communication at a transmitter, comprising: processing signaling indicating at least one time-varying demodulation reference signal (DMRS) pattern for DMRS combining; transmitting, according to the at least one time-varying DMRS pattern, at least a first DMRS in a first time interval and at least a second DMRS in at least a second time interval; and transmitting at least one data channel transmission in at least one of the first time interval or the at least the second time interval.

Clause 19: The method of Clause 18, wherein the at least one time-varying DMRS pattern indicates a first DMRS density for the first time interval and at least a second DMRS density for the at least the second time interval.

Clause 20: The method of any one of Clauses 18-19, wherein the first time interval comprises a first slot and the at least the second time interval comprises at least a second slot.

Clause 21: The method of any one of Clauses 18-20, wherein the first time interval is defined by a first Start and Length Indicator Value (SLIV) and the second time interval is defined by a second SLIV.

Clause 22: The method of any one of Clauses 18-21, wherein the data channel transmission comprises at least one of: a physical downlink shared channel (PDSCH) transmission, or a physical uplink shared channel (PUSCH) transmission.

Clause 23: The method of any one of Clauses 18-22, wherein the at least one time-varying DMRS pattern is indicated by at least one of: radio resource control (RRC) signaling, or downlink control information (DCI).

Clause 24: The method of any one of Clauses 18-23, wherein the second time interval occurs temporally after the first time interval.

Clause 25: The method of any one of Clauses 18-24, wherein the signaling comprises: first signaling defining a set of time varying DMRS patterns; and second signaling indicating a time varying DMRS pattern, from the set of time varying DMRS patterns, for DMRS combining.

Clause 26: The method of Clause 25, wherein: the first signaling comprises radio resource control (RRC) signaling; and the second signaling comprises downlink control information (DCI).

Clause 27: The method of Clause 25, wherein: the first signaling indicates at least a first DMRS pattern for use when DMRS combining is enabled and at least a second DMRS pattern for use when DMRS combining is disabled; and the second signaling indicates whether DMRS combining is enabled or disabled.

Clause 28: The method of any one of Clauses 18-27, wherein: the signaling indicates a quantity of DMRS symbols from one or more time intervals to be combined when performing channel estimation.

Clause 29: The method of any one of Clauses 18-28, wherein: the transmitter comprises a user equipment (UE); and the processing comprises receiving the signaling.

Clause 30: The method of any one of Clauses 18-29, wherein: the transmitter comprises a network entity; and the processing comprises transmitting the signaling.

Clause 31: An apparatus, comprising: at least one memory comprising executable instructions; and at least one processor configured to execute the executable instructions and cause the apparatus to perform a method in accordance with any combination of Clauses 1-30.

Clause 32: An apparatus, comprising means for performing a method in accordance with any combination of Clauses 1-30.

Clause 33: A non-transitory computer-readable medium comprising executable instructions that, when executed by at least one processor of an apparatus, cause the apparatus to perform a method in accordance with any combination of Clauses 1-30.

Clause 34: A computer program product embodied on a computer-readable storage medium comprising code for performing a method in accordance with any combination of Clauses 1-30.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a graphics processing unit (GPU), a neural processing unit (NPU), a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by a user equipment (UE) may also (or instead) be performed by a network entity (e.g., a base station or unit of a disaggregated base station). Similarly, operations performed by a network entity may also (or instead) be performed by a UE.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

Means for processing, means for receiving, means for performing, means for decoding, means for delaying, means for determining, and means for transmitting may comprise one or more processors, such as one or more of the processors described above with reference to FIG. 15.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication at a receiver, comprising:
at least one memory comprising computer-executable instructions; and
one or more processors configured to execute the computer-executable instructions and cause the apparatus to:
process signaling indicating at least one time-varying demodulation reference signal (DMRS) pattern for DMRS combining;
receive, according to the at least one time-varying DMRS pattern, at least a first DMRS in a first time interval and at least a second DMRS in at least a second time interval;
perform channel estimation based on DMRS combining of the first DMRS and the second DMRS; and
decode at least one data channel transmission based on the channel estimation.

2. The apparatus of claim 1, wherein the at least one time-varying DMRS pattern indicates a first DMRS density for the first time interval and at least a second DMRS density for the at least the second time interval.

3. The apparatus of claim 1, wherein the first time interval comprises a first slot and the at least the second time interval comprises at least a second slot.

4. The apparatus of claim 1, wherein the first time interval is defined by a first Start and Length Indicator Value (SLIV) and the second time interval is defined by a second SLIV.

5. The apparatus of claim 1, wherein the data channel transmission comprises at least one of:
a physical downlink shared channel (PDSCH) transmission, or
a physical uplink shared channel (PUSCH) transmission.

6. The apparatus of claim 1, wherein the at least one time-varying DMRS pattern is indicated by at least one of: radio resource control (RRC) signaling, or downlink control information (DCI).

7. The apparatus of claim 1, wherein the second time interval occurs temporally after the first time interval.

8. The apparatus of claim 7, wherein performing the channel estimation comprises:
averaging measurements of DMRS tones from the second time interval with stored measurements of DMRS tones from the first time interval; and
estimating channel characteristics for the second time interval based on the averaged measurements.

9. The apparatus of claim 7, wherein the one or more processors are further configured to cause the apparatus to:
delay decoding a data channel transmission for the first time interval until after reception of the at least the second DMRS.

10. The apparatus of claim 9, wherein performing the channel estimation comprises:
averaging measurements of DMRS tones from the first time interval with measurements of DMRS tones of the at least the second DMRS; and
estimating channel characteristics for the first time interval based on the averaged measurements.

11. The apparatus of claim 1, wherein the signaling comprises:
first signaling defining a set of time varying DMRS patterns; and
second signaling indicating a time varying DMRS pattern, from the set of time varying DMRS patterns, for DMRS combining.

12. The apparatus of claim 11, wherein:
the first signaling comprises radio resource control (RRC) signaling; and
the second signaling comprises downlink control information (DCI).

13. The apparatus of claim 11, wherein:
the first signaling indicates at least a first DMRS pattern for use when DMRS combining is enabled and at least a second DMRS pattern for use when DMRS combining is disabled; and
the second signaling indicates whether DMRS combining is enabled or disabled.

14. The apparatus of claim 1, wherein the signaling indicates a quantity of DMRS symbols from one or more time intervals to be combined when performing the channel estimation.

15. The apparatus of claim 14, wherein the one or more processors are further configured to cause the apparatus to:
determine the at least one time-varying DMRS pattern based on the indicated quantity.

16. The apparatus of claim 1, wherein:
the receiver comprises a user equipment (UE); and
the processing comprises receiving the signaling.

17. The apparatus of claim 1, wherein:
the receiver comprises a network entity; and
the processing comprises transmitting the signaling.

18. An apparatus for wireless communication at a transmitter, comprising:
at least one memory comprising computer-executable instructions; and
one or more processors configured to execute the computer-executable instructions and cause the apparatus to:
process signaling indicating at least one time-varying demodulation reference signal (DMRS) pattern for DMRS combining;
transmit, according to the at least one time-varying DMRS pattern, at least a first DMRS in a first time interval and at least a second DMRS in at least a second time interval; and
transmit at least one data channel transmission in at least one of the first time interval or the at least the second time interval.

19. The apparatus of claim 18, wherein the at least one time-varying DMRS pattern indicates a first DMRS density for the first time interval and at least a second DMRS density for the at least the second time interval.

20. A method for wireless communication at a receiver, comprising:
processing signaling indicating at least one time-varying demodulation reference signal (DMRS) pattern for DMRS combining;
receiving, according to the at least one time-varying DMRS pattern, at least a first DMRS in a first time interval and at least a second DMRS in at least a second time interval;
performing channel estimation based on DMRS combining of the first DMRS and the second DMRS; and
decoding at least one data channel transmission based on the channel estimation.
